(19) United States
(12) Patent Application Publication
(10) Pub. No.: US 2020/0211417 A1
(43) Pub. Date: Jul. 2, 2020

(54) TWO-LANGUAGE FREE DIALOGUE SYSTEM AND METHOD FOR LANGUAGE LEARNING

(71) Applicant: ELECTRONICS AND TELECOMMUNICATIONS RESEARCH INSTITUTE, Daejeon (KR)

(72) Inventor: Jinxia HUANG, Daejeon (KR)

(21) Appl. No.: 16/727,192

(22) Filed: Dec. 26, 2019

(30) Foreign Application Priority Data
Dec. 27, 2018 (KR) 10-2018-0170888

(51) Int. Cl. G09B 19/06; G06F 40/58; G10L 15/26; G06K 9/62

(52) U.S. Cl. CPC G09B 19/06; G06K 9/6267; G10L 15/265; G06F 40/58

(57) ABSTRACT

The present invention provides a two-language free dialogue system for language learning capable of responding to a query and a general dialogue in a learning target language even when a user produces an utterance not only in a designated learning target language but also in a native language, at a time of a dialogue-based foreign language education.

### CROSS-REFERENCE TO RELATED APPLICATION

This application claims priority to and the benefit of Korean Patent Application No. 10-2018-0170888, filed on Dec. 27, 2018, the disclosure of which is incorporated herein by reference in its entirety.

### BACKGROUND

### 1. Field of the Invention

The present invention relates to a two-language free dialogue system and method for language learning, and more specifically, to a two-language free dialogue system for language learning capable of providing a two-language free dialogue service at a time of utterance of a user regardless of whether the utterance is a native language or a learning target language.

### 2. Description of Related Art

In the conventional dialogue systems for foreign language education, a learner learns a foreign language dialogue scenario and practices a dialogue learned by conversing with the system to improve the proficiency.

To this end, the dialogue system allows some degree of flexibility in the order or expressions of dialogues according to a given dialogue scenario.

When a dialogue service for foreign language education using a dialogue scenario for ordering pizzas is provided, even in the case of a dialogue scenario for ordering pizzas constructed to order beverages after selecting pizzas, the dialogue system may change the scenario into a scenario for simultaneously ordering pizzas and beverages and may respond even when a user produces an utterance out of the contents of the dialogue scenario.

However, the conventional dialogue systems for foreign language education respond only in a language spoken by the user and therefor does not accord with the purpose of language learning through a dialogue.

In addition, the conventional free dialogue system is a system for fun and is also referred to as chat-bot. Such a conventional free dialogue system is further provided with fun by responding to a user's free utterance using a large amount of dialogue data.

However, even in the conventional free dialogue system, the user needs to consistently use only a language designated by the system, and the system also responds using the corresponding language.

When a learner desires to learn a language using such a conventional free dialogue system, the learner may only use a certain range of expressions the learner knows due to the limitation of language expressiveness of the learner, and thus the range of dialogues is narrow and the learner easily gives up the learning.

There are also goal-oriented dialogue systems, such as a personal assistant, in which a user may play jazz music, arrange a schedule, or even have some free dialogue through a dialogue with the system.

In particular, Google has recently published multilingual Google Assistant supporting two-languages simultaneously, which can respond to an utterance produced in any one of two-languages selected by a user, by using LokID Identification (LangID) technology developed in 2013.

However, the multilingual Google Assistant responds only in a language spoken by the user and therefore does not accord with the purpose of language learning through a dialogue

### SUMMARY OF THE INVENTION

The present invention provides a two-language free dialogue system for language learning capable of responding to a query and a general dialogue in a learning target language even when a user produces an utterance not only in a designated learning target language but also in a native language, at a time of a dialogue-based foreign language education.

The technical objectives of the present invention are not limited to the above, and other objectives may become apparent to those of ordinary skill in the art based on the following descriptions.

According to one aspect of the present invention, there is provided a two-language free dialogue system for language learning including: an input recognizer configured to recognize an input form and a type of input language of an input source language provided by a user; a speech recognizer configured to, when the recognized input form is a speech, convert the speech into a text; a native language intent analyzer configured to, when the recognized type of the input language is a native language, analyze a dialogue intent from the recognized native language; a learning target language intent analyzer configured to, when the recognized type of the input language is a learning target language, analyze a dialogue intent from the recognized learning target language; a translator configured to, when a dialogue intent of the user is recognized as a translation request through the native language intent analyzer, translate a translation target into the learning target language; and a dialogue processor configured to provide a system response according to a result of analyzing the dialogue intent provided through the learning target language intent analyzer and a result of processing a dialogue of a user utterance translated through the translator in the learning target language.

The input recognizer may include: an input form determiner configured to determine whether the input form is a speech or a text; and a language type determiner configured to determine whether the determined type of the input language is the native language, the learning target language, or a code switching type in which the native language and the learning target language are mixed.

The speech recognizer, in case that the input form is the speech, may include: a learning target language speech recognizer configured to, when the type of the input language is the learning target language, convert the speech into the text; a native language speech recognizer configured to, when the type of the input language is the native language, convert the speech into the text; a mixed speech recognizer configured to, when the type of the input language is a type of language in which the native language and the learning target language are combined, convert the speech into the text; and a language separator configured to separate the text converted from a mixed speech into the native language and the learning target language.

Meanwhile, each of the native language intent analyzer and the learning target language intent analyzer may include: an intent classifier configured to classify recognized intent of the user utterance into a general dialogue or a learning query; and a tag setter configured to set a tag for the intent classified user utterance.

In addition, the dialogue processor may further include: a tag identifier configured to identify the tag set for the intent classified user utterance; a learning query responder configured to, when the tag set for the user utterance is a tag regarding a learning query, process the learning query in the user utterance according to the tag attached to the user utterance; and a general dialogue responder configured to, when a result of identifying the tag set for the user utterance reveals that the user utterance has no tag regarding a learning query attached thereto or has a tag regarding a general dialogue attached thereto, provide the system response corresponding to the user utterance in the learning target language.

According to another aspect of the present invention, there is provided a two-language free dialogue method for language learning including: recognizing, by an input recognizer, an input form and a type of input language of an input source language provided by a user; when the input form is a speech, recognizing a speech for converting the speech into a text; when the recognized type of the input language is a learning target language, analyzing, by a learning target language intent analyzer, a dialogue intent from the recognized learning target language; when the recognized type of the input language is a native language, analyzing, by a native language intent analyzer, a dialogue intent from the recognized native language; when a dialogue intent of the user is recognized as a translation request through the native language intent analyzer, translating, by a translator, a translation target into the learning target language; and providing, by a dialogue processor, a system response according to a result of analyzing the dialogue intents provided through the learning target language intent analyzer and the native language intent analyzer and a result of receiving a user utterance translated through the translator and processing the received user utterance in the learning target language.

The recognizing of the input source language may include: determining, by an input form determiner, whether the recognized source language is a speech or a text; and determining the type of language of the recognized speech or text.

The two-language free dialogue method may further include, when the input form determined in the recognizing of the input source language is a speech, converting, by a speech recognizer, input in the form of the speech into a text.

The converting of the speech into the text may include, in case that the input form is the speech, recognizing a learning target language speech in which the speech is converted into the text when the type of the input language is the learning target language; recognizing a native language speech in which the speech is converted into the text when the type of the input language is the native language; recognizing a mixed speech in which the speech is converted into the text when the type of the input language is a type of language in which the native language and the learning target language are combined; and separating a language in which the text converted from a mixed speech is separated into the native language and the learning target language.

The analyzing of the dialogue intent from the recognized learning target language may include: classifying recognized intent of the user utterance into a general dialogue or a learning query; classifying the learning query into detailed learning queries; and setting, by a tag setter, a tag regarding the classified dialogue intent such that a tag for identifying the learning query is attached.

The analyzing of the dialogue intent from the recognized native language may include: classifying the recognized intent of the user utterance into a general dialogue or a learning query; classifying the learning query into detailed learning queries; and setting, by the tag setter, a tag regarding the classified dialogue intent such that a tag for identifying the learning query is attached to a query target.

The providing of the system response according to a response result for the intent classified user utterance in the learning target language may include: identifying, by a tag identifier, the tag set for the intent classified user utterance; when the tag set for the user utterance is a tag regarding a learning query, responding to a learning query in which the query in the user utterance is processed and responded according to a learning query type tag and a query target tag attached to the user utterance; and when the tag set for the user utterance is a tag regarding a general dialogue, responding to the general dialogue in which the system response corresponding to the user utterance is provided in the learning target language.

The processing of the dialogue may include collecting and identifying, by the tag identifier, results of the native language intent analyzer, the learning target language intent analyzer, and as needed, the translator when the recognized user utterance is a code switching input and is separated into the learning target language and the native language.

The classifying, by the intent classifier, of the dialogue intent may include performing determination on the basis of learning or on the basis of a rule and a pattern.

The recognizing, by the input recognizer, of the type of the input language may include using a sentence unit language recognition technology or a word unit language recognition technology for recognizing a code switching speech or text.

The converting, by the speech recognizer, of the input speech into the text may use independent monolingual speech recognition technologies and use a multilingual speech recognition technology according to the determined types of language. The multilingual speech recognition technology may employ a unified multilingual speech recognition technology that is constructed using acoustic models, pronunciation dictionaries, and language models for a native language and a learning target language. In particular, when it is determined as a result of determining the type of language, that one utterance is an utterance produced in a native language or a learning target language rather than a code switching utterance in which the two languages are mixed, and the determination has a high reliability, the independent monolingual speech recognition device is used, and when it is determined that one utterance is a code switching utterance or when the utterance is determined to be produced in a mono language but the determination has a low reliability, the multilingual speech recognition technology may be used.

The providing, by a learning query responder of the dialogue processor, of the response to the learning query may include responding to a query on a pronunciation of a learning target language word, a query on a translation word, a query on a learning target language spelling, and a question on a translation expression of a native language expression to be subject to question by using a learning target language pronunciation dictionary, a learning target language dictionary, a native language-learning target language translation dictionary, a translation result provided by the translator, and the like.

A general dialogue responder of the dialogue processor may use a method of providing a response to a user utterance through a search-based technology using a learning target language dialogue example corpus; a method of generating a response to a user utterance through a deep learning technology using a dialogue model learned with a two-language large volume dialogue corpus; and a method of responding to a user utterance through a rule-based technology.

### BRIEF DESCRIPTION OF THE DRAWINGS

FIG. 1 is a block diagram for describing a two-language free dialogue system for language learning according to an embodiment of the present invention.

FIG. 2 is a diagram for describing a detailed configuration block for processing determination of the form and the type of language input to an input recognizer shown in FIG. 1;

FIG. 3 is a diagram for describing a detailed configuration block for recognizing a speech by a speech recognizer shown in FIG. 1 according to the type of language;

FIG. 4 is a diagram for describing a detailed configuration block of a learning target language intent analyzer and a native language intent analyzer shown in FIG. 1;

FIG. 5 is a detailed block diagram for describing a dialogue processor shown in FIG. 1;

FIG. 6 is a flowchart for describing a two-language free dialogue method for language learning according to an embodiment of the present invention.

FIG. 7 is a flowchart for describing an operation of determining the form and the type of language of an input source language according to an embodiment of the present invention.

FIG. 8 is a flowchart for describing a source language processing method which corresponds to an operation of recognizing the form and the type of language of an input source language according to an embodiment of the present invention.

FIG. 9 is a flowchart for describing a detailed operation of analyzing a dialogue intent in a recognized learning target language according to an embodiment of the present invention.

FIG. 10 is a flowchart for describing a detailed operation of providing a system response resulting from a dialogue intent analysis shown in FIG. 6 through a learning target language.

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings. However, the scope of the present invention is not limited to such embodiments, and the present invention may be embodied in various forms. The embodiments to be described below are embodiments provided only to complete the disclosure of the present invention and assist those skilled in the art in fully understanding the scope of the present invention, and the present invention is defined only by the scope of the appended claims. Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

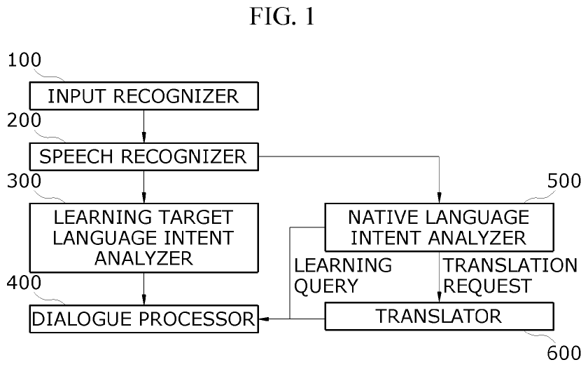

Hereinafter, exemplary embodiments of the present invention will be described in detail with reference to the accompanying drawings. FIG. 1 is a block diagram for describing a two-language free dialogue system for language learning according to an embodiment of the present invention.

Referring to FIG. 1, the two-language free dialogue system for language learning according to the embodiment of the present invention, which is designed to learn a learning target language, may provide a user with a response to the user's utterance when the user produces the utterance using a learning target language, a native language, or a combination of the learning target language and the native language.

The two-language free dialogue system for language learning according to the embodiment of the present invention includes an input recognizer 100, a speech recognizer 200, a learning target language intent analyzer 300, a dialogue processor 400, a native language intent analyzer 500, and a translator 600.

The input recognizer 100 recognizes the form and the type of language of an input source language provided by a user. In this case, the input recognizer 100 may receive the input source language from the user in various methods. The input recognizer 100 according to the present embodiment may exemplarily receive the input source language spoken directly by a user through a microphone or a mobile terminal but may also receive the input source language in the form of a text input through a keyboard or a mobile terminal.

The speech recognizer 200, when the recognized form of the input is a speech, converts the speech into a text.

The learning target language intent analyzer 300, when the recognized type of language of the input is a learning target language, analyzes a dialogue intent from the recognized learning target language.

The dialogue processor 400 provides a user with a result of processing a dialogue of a user utterance composed in the learning target language and/or a user utterance translated through the translator 600, by referring to a result of analyzing dialogue intents provided through the learning target language intent analyzer 300 and the native language intent analyzer 500, in the learning target language.

The native language intent analyzer 500, when the recognized type of language of the input is a native language, analyzes a dialogue intent from the recognized native language.

In addition, the translator 600, when a dialogue intent of the user is recognized as a translation request through the native language intent analyzer 500, translates a translation target into the learning target language and provides the dialogue processor 400 with a result of the translation.

Therefore, according to the embodiment of the present invention, the user may be provided with a foreign language learning service by having a dialogue with the system through a learning target language, and even when the user inquires or converses with the system using a native language due to limitation of expressiveness of a specific learning target language, the system recognizes the native language provided by the user and provides a question answering result according to the recognition, thereby providing an environment allowing the user to feel as if having a casual dialogue with a foreign language teacher who knows the native language of the user in language learning.

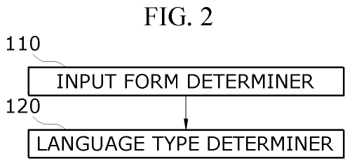

FIG. 2 is a diagram for describing a detailed configuration block for processing determination of the form and the type of language input to an input recognizer shown in FIG. 1.

As shown in FIG. 2, the input recognizer 100 according to the exemplary embodiment of the present invention includes an input form determiner 110 and a language type determiner 120.

The input form determiner 110 determines whether the form of the input is a speech or a text.

The language type determiner 120 determines whether the type of language of the determined input is a native language, a learning target language, or a code switching type in which the native language and the learning target language are mixed. In this case, in order to determine the type of language, the language type determiner 120 may use a sentence unit language recognition technology or may use a word unit language recognition technology for recognizing a code switching speech or text.

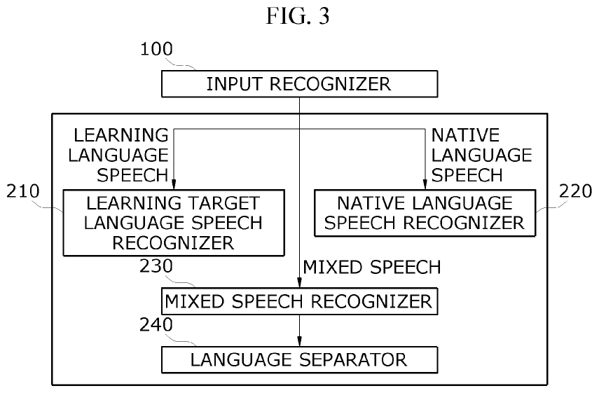

FIG. 3 is a diagram for describing a detailed configuration block for recognizing a speech by the speech recognizer shown in FIG. 1 according to a language type.

As shown in FIG. 3, the speech recognizer 200 includes a learning target language speech recognizer 210, a native language speech recognizer 220, a mixed speech recognizer 230, and a language separator 240.

The learning target language speech recognizer 210, when the form of the input is a speech and the type of language of the input is a learning target language, converts the input into a text.

The native language speech recognizer 220, when the form of the input is a speech and the type of language of the input is a native language, converts the input into a text.

In addition, the mixed speech recognizer 230, when the type of language of the input is a type of combination of a native language and a learning target language, converts the input into a text. To this end, the mixed speech recognizer 230 may be exemplarily provided using a multilingual speech recognition technology. The multilingual speech recognition technology may exemplarily employ a unified multilingual speech recognition technology that is constructed using acoustic models, pronunciation dictionaries, and language models for a native language and a learning target language.

In addition, the language separator 240 serves to separate a text converted from a mixed speech into the native language and the learning target language. The native language and the learning target language separated from the input source language are provided to the native language intent analyzer 500 and the learning target language intent analyzer 300, respectively.

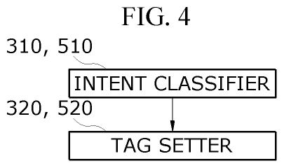

FIG. 4 is a diagram for describing a detailed configuration block of a learning target language intent analyzer and a native language intent analyzer shown in FIG. 1.

As shown in FIG. 4, the learning target language intent analyzer 300 and the native language intent analyzer 500 may each include an intent classifier 310 or 510 and a tag setter 320 or 520.

The intent classifier 310 or 510 serves to classify whether the recognized intent of the user utterance is a general dialogue or a learning query. Here, the intent classifier 310 or 510 may perform the determination on the basis of learning or on the basis of rule and pattern.

In the following, an example of a query in which a user utterance is constructed in a native language (Korean) will be described.

N|ative Language Example 1) [symbol] [symbol] [translate] “Sea salt.”,

|Native Language Example 2) [symbol] [symbol] [translate] “Sea Salt.”,

Native Language Example 3) [symbol] [symbol] [translate, spell] “Typhoon.”,

Native Language Example 4) [symbol] [symbol] [translate, conversation] “What a terrible typhoon we have today.”,

Native Language Example 5) [symbol] [symbol] [symbol] [translate] “What a ter e typhoon we have today.”,

In the above, Example 4) is a case in which the user desires to have a general dialogue in Korean, in which case the translator 600 translates the utterance, the dialogue processor 400 regards the translated utterance as a general dialogue, searches for or generates a response to the translated utterance, and transmits the response to the user in the learning target language.

On the other hand, Example 5) is a case in which the user desires an English translation of the corresponding Korean expression, in which case the translator 600 translates the utterance, and the dialogue processor 400 provides the user with the translation itself.

In the following, an example of a query in which a user utterance is constructed in a learning target language (English) will be described.

Learning Target Language Example 1) What is the spelling of typhoon?->[spell] “typhoon”

Learning Target Language Example 2) Tell me the spelling of typhoon?->[spell] “typhoon”

Learning Target Language Example 3) Spelling of typhoon please?->[spell] “typhoon”

Learning Target Language Example 4) What a terrible typhoon we have today. ->[conversation] “What a terrible typhoon we have today.”

In the following, an example of a query in which a user utterance is constructed in a code switching speech will be described.

Code Switching Example 1) How can I say [symbol] [translate] “Sea Salt”,

Code Switching Example 2) Tell me the spelling of [symbol] [translate spell] “Sea Salt”,

Code Switching Example 3) [symbol] [symbol] [spell] “typhoon”,

Code Switching Example 4) [symbol] [symbol] [pronounce] “typhoon”,

Code Switching Example 5) How can I say [symbol] [symbol] [translate] “What a terrible Typhoon we have today”.

In the embodiment of the code switching utterance, the intent analysis of the English language part, which is the learning target language, is performed by the learning target language intent classifier 310, and the intent analysis of the Korean language part, which is the native language, is performed by the native language intent classifier 510, and the respective results of intent analysis are input to the dialogue processor 400 and processed, but the processing of the code switching utterance is not limited thereto. According to performance and needs, a mixed-language intent analyzer for code switching inputs may be used.

In addition, the tag setter 320 or 520 serves to set a tag for the user utterance in which the intent is classified. In the present embodiment, the tag set by the tag setter 320 or 520 may be limited to a query used for learning, such as a translation and a spelling, but the function of the tag is not limited thereto.

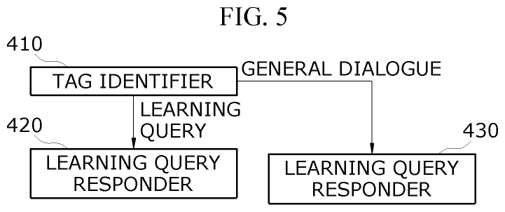

FIG. 5 is a detailed configuration block for describing the dialogue processor 400 shown in FIG. 1.

As shown in FIG. 5, the dialogue processor 400 includes a tag identifier 410, a learning query responder 420, and a general dialogue responder 430.

The tag identifier 410 serves to identify a tag set for the user utterance in which the intent has been classified.

The learning query responder 420, when the tag set for the user utterance is a tag regarding a learning query, serves to process the learning query in the user utterance according to a tag attached to the user utterance.

On the other hand, the general dialogue responder 430, when a result of identifying the tag set for the user utterance reveals that the user utterance has no tag regarding a learning query attached thereto or has a tag regarding a general dialogue attached thereto, provides a system response corresponding to the user utterance in a learning target language.

As such, a user utterance to which a set tag is not attached represents that a dialogue service for foreign language education with the system is performed on the user through the learning target language.

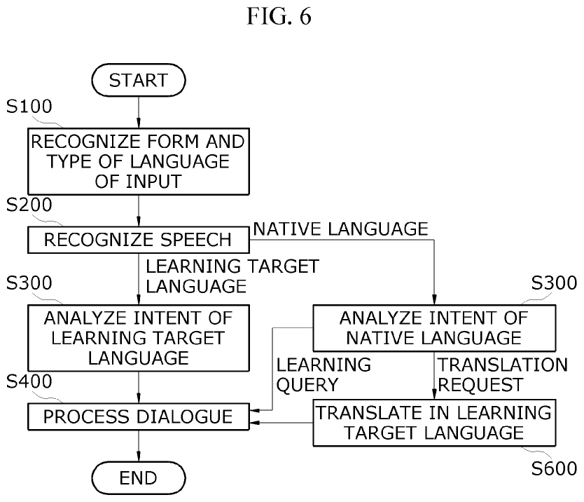

Hereinafter, a two-language free dialogue method for language learning according to an embodiment of the present invention will be described with reference to FIG. 6.

First, the input recognizer 100 recognizes the form and the type of language of an input source language provided by a user (S100). In operation S100 of recognizing the form and the type of language of the input source language, the speech recognizer 200 may use a sentence unit language recognition technology or may use a word unit language recognition technology for recognizing a code switching utterance.

The speech recognizer 200, when the recognized form of the input is a speech, converts the speech into a text (S200).

The learning target language intent analyzer 300, when the type of language of the input recognized through the input recognizer 100 is a learning target language, analyzes a dialogue intent from the recognized learning target language (S300).

Subsequently, the dialogue processor 400 provides the user with a result of analyzing the dialogue intent provided through the learning target language intent analyzer 300 in the learning target language (S400).

On the contrary, when the type of language of the input recognized through the input recognizer 100 is a native language, the native language intent analyzer 500 analyzes a dialogue intent from the recognized native language (S500).

Thereafter, the translator 600, when the dialogue intent of the user is recognized as a translation request through the native language intent analyzer 500, translates a translation target into the learning target language (S600).

Subsequently, the dialogue processor 400 provides the user with a result of analyzing the dialogue intent translated through the translator 600 in the learning target language (S400).

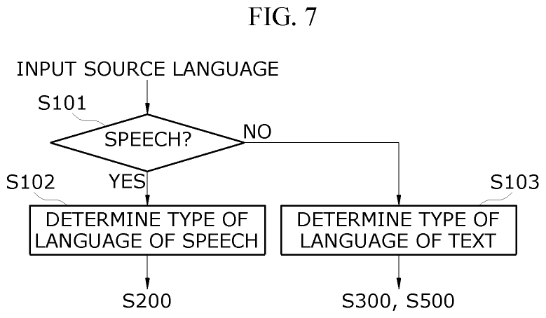

In operation S100 of determining the recognized form and type of language of the input, it is determined whether the form of the input is a speech or a text as shown in FIG. 7 (S101).

Thereafter, when the form of the input is a speech, it is determined whether the type of language with respect to the speech is a native language, a learning target language, or a code switching type in which the native language and the learning target language are mixed with respect to the speech (S102).

On the other hand, when the form of the input is a text, it is determined whether the type of language with respect to the text is a native language, a learning target language, or a code switching type in which the native language and the learning target language are mixed with respect to the text (S103).

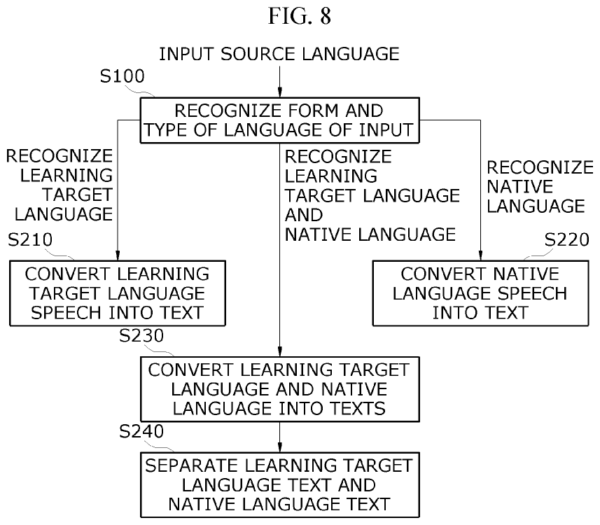

FIG. 8 is a flowchart for describing a source language processing method which corresponds to operation S200 of converting a speech into a text according to an embodiment of the present invention.

First, when the type of language recognized by the input recognizer 100 is a learning target language, the learning target language speech recognizer 210 converts the learning target language speech into a text (S210).

When the type of language recognized by the input recognizer 100 is a native language, the native language speech is converted into a text (S220).

Here, when the source language is the learning target language, operation S300 of analyzing the dialogue intent from the learning target language is performed, and when the source language is the native language, operation S500 of analyzing the dialogue intent from the native language is performed.

On the contrary, when the type of language recognized by the input recognizer 100 is a type having a mixture of the learning target language and the native language, the mixed speech recognizer 230 converts the learning target language and the native language into respective texts (S230).

Thereafter, the learning target language and the native language converted into texts are separated from each other (S240). The learning target language in the source language separated as such is subject to operation S300 of analyzing the dialogue intent from the learning target language, and the native language in the source language separated as such is subject to operation S500 of analyzing the dialogue intent from the native language.

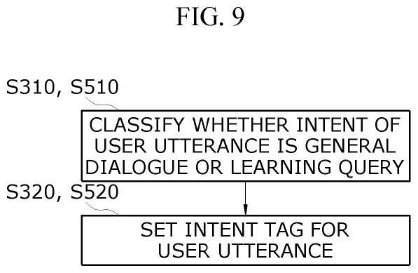

Hereinafter, operation S300 of analyzing the dialogue intent from the recognized learning target language according to the embodiment of the present invention will be described with reference to FIG. 9.

First, the intent classifier 310 or 510 classifies whether the recognized intent of the user utterance is a general dialogue or a learning query (S310). Here, operation S310 of classification performs the determination on the basis of learning or on the basis of rules or patterns.

Subsequently, the tag setter 320 or 520 sets a tag for the user utterance in which the intent is classified (S320).

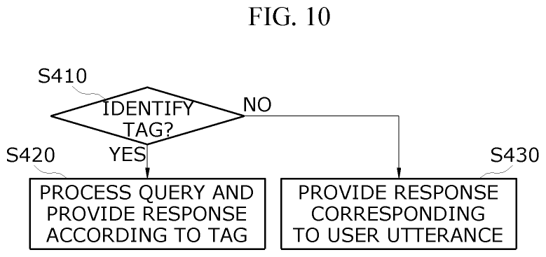

Meanwhile, a detailed operation of operation S500 of providing a dialogue processing result with respect to a result of analyzing the dialogue intent (i.e., a system response) in the learning target language will be described with reference to FIG. 10.

First, the tag identifier 410 identifies a tag set for the user utterance in which the intent is classified (S410).

Thereafter, when the tag set for the user utterance is a tag regarding a learning query, the learning query responder 420 processes the learning query in the user utterance according to a tag attached to the user utterance (S420). In order to provide a response to the learning query, a translation dictionary, a word pronunciation dictionary, a spelling pronunciation dictionary, a speech generation technology, and the like may be used, but the providing of the response is not limited thereto.

On the other hand, when a result of identifying the tag set for the user utterance reveals that the user utterance has no tag regarding a learning query attached thereto or has a tag regarding a general dialogue attached thereto, the general dialogue responder 430 provides a system response corresponding to the user utterance in the learning target language (S430).

The system responses to general dialogues may be provided using a given scenario, dialogue rules and patterns, dialogue examples, or a large volume dialogue corpus. In addition, the dialogue response technology may be provided using rule and/or pattern-based technology, search-based technology, or deep learning-based technology, but is not limited thereto.

As is apparent from the above, a user can be provided with a foreign language learning service by conversing with a system through a learning target language and can be provided with a foreign language learning service in which the user converses with the system using a native language due to limitation of expression power of a specific learning target language while the system responds using the learning target language, and in addition, even when the user transmits a query to the system about an incomplete expression using a learning target language or a native language due to limitation of expression power of the specific learning target language, the system recognizes the native language or the mixed two-language expression provided by the user and provides a result of the recognition, thereby providing an environment allowing the user to feel as if having a casual dialogue with a foreign language teacher who knows the native language of the user in language learning.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

What is claimed is:

1. A two-language free dialogue system for language learning, comprising:
an input recognizer configured to recognize an input form and a type of input language of an input source language provided by a user;
a speech recognizer configured to, when the recognized the input form is a speech, convert the speech into a text;
a native language intent analyzer configured to, when the recognized type of the input language is a native language, analyze a dialogue intent from the recognized native language;
a learning target language intent analyzer configured to, when the recognized type of the input language is a learning target language, analyze a dialogue intent from the recognized learning target language;
a translator configured to, when a dialogue intent of the user is recognized as a translation request through the native language intent analyzer, translate a translation target into the learning target language; and
a dialogue processor configured to provide a system response according to a result of analyzing the dialogue intent provided through the learning target language intent analyzer and a result of processing a dialogue of a user utterance translated through the translator in the learning target language.

2. The two-language free dialogue system of claim 1, wherein the input recognizer includes an input form determiner configured to determine whether the input form is a speech or a text.

3. The two-language free dialogue system of claim 1, further comprising a language type determiner configured to determine whether the determined type of the input language is the native language, the learning target language, or a code switching type in which the native language and the learning target language are mixed.

4. The two-language free dialogue system of claim 1, wherein the speech recognizer, in case that the input form is the speech, includes:
a learning target language speech recognizer configured to, when the type of the input language is the learning target language, convert the speech into the text;
a native language speech recognizer configured to, when the type of the input language is the native language, convert the speech into the text;
a mixed speech recognizer configured to, when the type of the input language is a type of language in which the native language and the learning target language are combined, convert the speech into the text; and
a language separator configured to separate the text converted from a mixed speech into the native language and the learning target language.

5. The two-language free dialogue system of claim 1, wherein each of the native language intent analyzer and the learning target language intent analyzer includes:
an intent classifier configured to classify recognized intent of the user utterance into a general dialogue or a learning query; and
a tag setter configured to set a tag regarding the classified intent.

6. The two-language free dialogue system of claim 5, wherein the dialogue processor includes:
a tag identifier configured to identify the tag set for the user utterance in which the intent is classified; and
a learning query responder configured to, when the tag set for the user utterance is a tag regarding a learning query, process the learning query in the user utterance according to the tag attached to the user utterance.

7. The two-language free dialogue system of claim 6, wherein the dialogue processor further comprises a general dialogue responder configured to, when a result of identifying the tag set for the user utterance reveals that the user utterance has no tag regarding a learning query attached thereto or has a tag regarding a general dialogue attached thereto, provide the system response corresponding to the user utterance in the learning target language.

8. The two-language free dialogue system of claim 5, wherein the intent classifier performs determination on the basis of learning or on the basis of a rule and a pattern.

9. The two-language free dialogue system of claim 7, wherein the dialogue processor provides a response to the general dialogue on the basis of generation including at least one of a rule and pattern-based technology, a search-based technology, and a deep learning technology.

10. The two-language free dialogue system of claim 1, wherein the speech recognizer uses a sentence unit language recognition technology.

11. The two-language free dialogue system of claim 1, wherein the speech recognizer uses a word unit language recognition technology for recognizing a code switching speech or text.

12. A two-language free dialogue method for language learning, comprising:
recognizing, by an input recognizer, an input form and a type of input language of an input source language provided by a user;
when the recognized input form is a speech, recognizing a speech for converting the speech into a text;
when the recognized type of the input language is a native language, analyzing, by a native language intent analyzer, a dialogue intent from the recognized native language;
when the recognized type of the input language is a learning target language, analyzing, by a learning target language intent analyzer, a dialogue intent from the recognized learning target language;
when a dialogue intent of the user is recognized as a translation request through the native language intent analyzer, translating, by a translator, a translation target into the learning target language; and
providing, by a dialogue processor, a system response according to a result of analyzing the dialogue intent provided through the learning target language intent analyzer and a result of processing a dialogue of a user utterance translated through the translator in the learning target language.

13. The two-language free dialogue method of claim 12, wherein the recognizing, by the input recognizer, of the input form and the type of the input language of the input source language provided by the user includes determining, by an input form determiner, whether the input form is a speech or a text.

14. The two-language free dialogue method of claim 12, wherein the recognizing, by the input recognizer, of the input form and the type of the input language of the input source language provided by the user includes determining, by a language type determiner, whether the determined type of the input language is the native language, the learning target language, or a code switching type in which the native language and the learning target language are mixed.

15. The two-language free dialogue method of claim 12, wherein the converting, when the recognized input form is the speech, of the speech into the text includes:
when the type of the input language is the learning target language, converting, by a learning target language speech recognizer, the speech into the text;
when the type of the input language is the native language, converting, by a native language speech recognizer, the speech into the text;
when the type of the input language is a type of language in which the native language and the learning target language are combined, converting, by a mixed speech recognizer, the speech into the text; and
separating, by a language separator, the text converted from a mixed speech into the native language and the learning target language.

16. The two-language free dialogue method of claim 12, wherein the analyzing of the dialogue intent includes:
classifying, by an intent classifier, recognized intent of the user utterance into a general dialogue or a learning query; and
setting, by a tag setter, a tag for the user utterance in which the intent is classified.

17. The two-language free dialogue method of claim 16, wherein the providing of the system response according to the result of analyzing the dialogue intent in the learning target language includes:
identifying, by a tag identifier, the tag set for the user utterance in which the intent is classified; and
when the tag set for the user utterance is a tag regarding a learning query, processing, by a learning query responder, the learning query in the user utterance according to the tag attached to the user utterance.

18. The two-language free dialogue method of claim 17, wherein the providing of the system response according to the result of analyzing the dialogue intent in the learning target language includes, when a result of identifying the tag set for the user utterance reveals that the user utterance has no tag regarding a learning query attached thereto or has a tag regarding a general dialogue attached thereto, providing, by a general dialogue responder, the system response corresponding to the user utterance in the learning target language.

19. The two-language free dialogue method of claim 17, wherein the classifying includes performing, by the intent classifier, determination on the basis of learning or on the basis of a rule and a pattern.

20. The two-language free dialogue method of claim 18, wherein the processing of the dialogue includes providing a response to the general dialogue on the basis of generation including at least one of a rule and pattern-based technology, a search-based technology, and a deep learning technology.
